(19) United States
(12) Patent Application Publication
(10) Pub. No.: US 2022/0404576 A1
(43) Pub. Date: Dec. 22, 2022

(54) LENS UNIT AND CAMERA MODULE

(71) Applicant: MAXELL, LTD., Otokuni-gun, Kyoto (JP)

(72) Inventor: Hiroyuki HIRATA, Otokuni-gun (JP)

(73) Assignee: MAXELL, LTD., Otokuni-gun, Kyoto (JP)

(21) Appl. No.: 17/771,584

(22) PCT Filed: Oct. 30, 2020
(86) PCT No.: PCT/JP2020/040777

§ 371 Date: Apr. 25, 2022

(30) Foreign Application Priority Data
Oct. 31, 2019 (JP) 2019-199327
Aug. 18, 2020 (JP) 2020-137893
Aug. 18, 2020 (JP) 2020-137900
Aug. 18, 2020 (JP) 2020-137901

(51) Int. Cl. G02B 7/02; G03B 17/55

(52) U.S. Cl. CPC G02B 7/021; G03B 17/55; G03B 17/08

(57) ABSTRACT

A lens unit and a camera module in which the electrical wiring extending from the electrically functional component in the lens barrel can be guided to the image side without interfering with an assembly operation, without the need of ensuring a wiring space in the lens barrel, and without forming an elongated through hole in the lens barrel. The lens barrel includes: i) a first through hole extending in the longitudinal direction inside the side wall to guide the electric wiring from the component to the image side end of the flange; ii) a second through hole extending radially on the side wall so the first through hole can communicate with the outside of the barrel; iii) an accommodation groove on the outer peripheral surface of the side wall to communicate with the second through hole, in order to accommodate the wiring and guide the wiring to the image side.

### TECHNICAL FIELD

The present invention relates to a lens unit and a camera module, and more particularly to a lens unit and a camera module for use in an in-vehicle camera mounted on a vehicle such as an automobile.

### BACKGROUND ART

Recently, in-vehicle cameras have been installed in automobiles to support parking and to prevent collisions by using image recognition, and attempts have been made to apply them to automatic driving. In addition, a camera module of such an in-vehicle camera usually has a lens unit including: a lens group in which a plurality of lenses are arranged along an optical axis; a lens barrel for accommodating and holding the lens group; an diaphragm placed in at least one position between lens pieces of the lens group (see, for example, Patent Document 1).

The lens unit (camera module) having the above configuration can be used not only in an in-vehicle camera, but also in various optical apparatus. In particular, when the lens is exposed to an outside environment in a cold region, since it can be usually assumed that the lens may freeze or snow may be attached to the lens, the lens is generally provided with a snow melting function or the like. Specifically, for example, as shown in FIG. 21, a heater 130 is inserted between a surface 101a of the first lens 101 facing the image side and a surface 102a of the second lens 102 adjacent to the first lens 101 facing the object side, in a manner such that it is possible to warm the first lens 101 located on the most object side in the lens group L accommodated and held in the lens barrel 120. Here, the first lens 101 is exposed from the lens barrel 120 (exposed to the outside environment).

The heater 130 incorporated in the lens barrel 120 in this way is widely used as the most effective heating part capable of efficiently transferring a generated heat to the surface of the first lens 101.

Further, Patent Document 2 discloses a lens unit capable of ensuring an airtight state inside the lens barrel so as to prevent a freezing of the front surface of the lens and a fogging of the lens. In such a lens unit, four lenses are arranged side by side in the lens barrel along the optical axis. On the object side, an O-ring is disposed between the first lens located on the most object side and the inner peripheral surface of the lens barrel, thus ensuring a desired sealing effect. Further, on the image side (capturing element side), a desired sealing effect can be ensured by attaching an optical filter to the lens barrel using an adhesive. In this way, it is possible to ensure an airtightness inside the lens barrel by using a seal on the object side and a seal on the image forming side, and to prevent a fogging of the lens.

### CITATION LIST

Patent Document
Patent Document 1: Japanese Unexamined Patent Application Publication No. 2013-231993
Patent Document 2: Japanese Unexamined Patent Application Publication No. 2008-233512

### SUMMARY OF THE INVENTION

### Technical Problems

On the other hand, a power supply to the heater 130 is obtained via an electric wiring and usually obtained by using a lead wire 140. As shown in in FIG. 21, such a lead wire 140 may has one end attached to the heater 130 by soldering, and the other end thereof led out of the lens barrel through a drawing hole 120a provided on side surface of the lens barrel 120 on the image side (lower portion of FIG. 21) of flange 120b located on the object side of the lens barrel 120.

However, since the flange 120b is a part for use in attaching the lens unit to the camera case, the lead wire 140 may be an obstacle during such an attachment. This is because the lead wire 140 is led out of the image side of the flange 120b to the outside and long extending for electrical connection.

Therefore, it is conceivable to extend the lead wire 140 in the lens barrel 120 to lead the lead wire 140 to the outside on the image side. However, in order to obtain a desired resolution, a lens unit is assembled by attaching a plurality of lenses (for example, 4-7 lenses) into the lens barrel 120 in a laminated and fitted state with an extremely high precision (if an element precision is poor, the optical axis will be displaced and tilted, and the desired resolution cannot be obtained). As a result, it is difficult to ensure a space in the lens barrel 120 for arranging the lead wire 140 in the lens barrel 120 and for leading the lead wire 140 to the outside on the image side.

Further, in view of the difficulty of ensuring the wiring space in the lens barrel, it is conceivable to provide a long and thin through hole in the side wall of the lens barrel 120 over almost an entire length of the barrel in the longitudinal direction (from the object side to the image side). However, if this is to be done with the metal lens barrel 120, a small diameter and long end mill for cutting has to be used, and this will cause a possibility that the end mill may sometimes break. On the other hand, if the resin lens barrel 120 is to be provided with such an elongated through hole in the side wall, a small diameter and long pin-shaped insert for mold parts is required in the mold. As a result, there is a risk that the pin-shaped insert may fall or break, or you may have to make a more complicated mold.

Attempts to form an elongated through hole in the lens barrel itself over almost the entire length of the barrel in the longitudinal direction are not realistic because they require advanced technology and make industrial mass production difficult.

Further, the above problems may occur not only in the wiring of the heater, but also in the wiring of all the electrically functional component used in the lens unit.

Further, as described above, even if the airtight state inside the lens barrel is ensured by using an O-ring or the like, it is still difficult to ensure a complete airtight state, and when a difference between the outside air temperature and the temperature inside the lens unit becomes large, water vapor in the lens unit will condenses and dew condensation will occur on the lens surface. In particular, dew condensation will occur in the inter-lens space between the first lens (the lens located closest to the object side) and the second lens adjacent to the first lens (the first lens is most affected by the temperature difference between inside the outside), especially on the back surface of the first lens.

Accordingly, in order to remove a dew condensation on the back surface of the first lens, it is conceivable to heat the first lens with a planar heater such as an FPC heater. The planar heater is formed in the shape of a donut plate and includes a heating portion for heating the first lens and a belt-shaped extending portion extending from the heating portion to supply electricity to the heating portion.

On the other hand, the lens barrel has an inner peripheral surface formed in a circular shape and has an accommodating/holding portion for accommodating and holding a plurality of lenses. However, the outer peripheral surface of the lens is used for positioning the lens in the radial direction, and it is in contact with the accommodating/holding portion. As a result, it is difficult to freely route the extending portion of the planar heater inside the lens barrel and lead it to the outside.

In this way, if the inner peripheral surface of the accommodating/holding portion is formed into a polygonal shape and if the circular lens is supported on the inner peripheral surface at a plurality of points, a gap will be formed between the inner peripheral surface of the accommodating/holding portion and the outer peripheral surface of the lens. Accordingly, the extending portion of the planar heater can be passed through the gap, so that the extending portion can be routed freely in the lens barrel.

However, since it is necessary to reduce the electric resistance of the electrical wiring formed in the extending portion for the purpose of reducing a generated heat as much as possible, it is required that the electric wiring be formed to have a predetermined width. Inevitably, the extending portion itself also needs a predetermined width. Namely, although the extending portion has a belt-shaped copper foil, the extending portion needs to have a certain width since the copper foil needs to have a certain width in order to reduce the electric resistance. For this reason, not only is it difficult to pass the extending portion through the gap, but if the extending portion is forcibly passed, the extending portion may hit the outer peripheral surface of the lens and the lens may be displaced (becomes eccentric).

The present invention has been accomplished in view of the above circumstances, and it is an object of the present invention to provide a lens unit and a camera module in which the electrical wiring extending from the electrically functional component provided in the lens barrel can be guided to the image side or in which the extending portion of the planar heater provided in the lens barrel can be easily routed inside the lens barrel to the outside without interfering with an assembly operation, without the need of ensuring a wiring space in the lens barrel, and without forming an elongated through hole in the lens barrel over almost the entire length thereof.

### Solution to Problems

In order to solve the avobe-mentioned problems, the lens unit of the present invention having: a lens group including a plurality of lenses arranged along optical axis of these lens; a lens barrel accommodating the lens group, said lens unit comprising:

a flange provided to project radially outward from the lens barrel and useful for attaching the lens unit to other member;

an electrically functional component located closer to the object side than the flange and provided within the lens barrel; and

an electrical wiring extending from the electrically functional component,

wherein

the lens barrel is provided with a first through hole or a first accommodating groove and a second accommodating groove,

the first through hole or the first accommodating groove is extending in the longitudinal direction from the object side to the image side inside the side wall of the lens barrel in order to guide the electrical wiring to a position closer to the image side than the image side end of the flange,

the second accommodating groove is communicated with the first through hole or the first accommodating groove, and extending in the longitudinal direction from the object side to the image side on the outer peripheral surface of the side wall of the lens barrel to accommodate the electrical wiring and guide the electrical wiring to the image side.

Here, Examples of electrically functional component include, but are not limited to, a planar heater capable of heating the first lens located closest to the object side.

For example, the following components may also be considered.

Examples of electrically functional components include an ITO film (formed on the lens surface) and an electrode, various sensors (such as temperature sensor, and distance sensor (using ultrasonic, millimeter-wave radar)), and drive mechanism for moving the lens.

As described above, in the present invention, a wiring guide portion provided in the side wall of the lens barrel for guiding the electrical wiring is divided into two portions (inside and outside portions with the flange serving as the boundary), a wiring guide portion extending closer to the object side than the flange is provided inside the lens barrel side wall as a through hole (first through hole) or a wiring accommodating groove (first accommodating groove), and another wiring guide portion extending closer to the image side than the flange is provided on the outside of the side wall of the barrel as a wiring accommodating groove (second accommodating groove). Accordingly, the electrical wiring led out to the outside of the lens barrel does not interfere with the assembly using the flange, and it is not necessary to ensure a wiring space inside the lens barrel. Further, since the accommodating portion of the electric wiring led out to the outside of the lens barrel is formed in a groove shape, it is not necessary to increase the outer diameter of the lens barrel.

Further, in the present invention, by limiting the formation of the through hole in the side wall of the lens barrel closer to the object side than the flange, it is not necessary to form an elongated through hole in the lens barrel over almost the entire length thereof. Therefore, it is possible to avoid the above-mentioned breakage of the end mill, a concern when forming such a through hole in a metal lens barrel. It is also possible to prevent the above-mentioned tilting and breaking of the insert for mold parts or the complication of the mold structure, a concern when forming such a through hole in molding a resin lens barrel. As a result, industrial mass production becomes possible.

In the above configuration, the electrical wiring is provided in a manner such that one end thereof is electrically connected to an electrically functional component by, for example, soldering, and the other end thereof is at first led out to the outside of the lens barrel via the first through hole or the first accommodating groove, and then electrically connected to the power supply on the image side while being accommodated and guided by the second accommodating groove.

Further, in the above configuration, it is preferable that the through holes and the accommodating grooves extend substantially parallel to the optical axis in order to ensure the shortest distance, and the number thereof is not particularly limited. Moreover, the object-side end of the first through hole or the first accommodating groove is preferably formed as a long hole or a long groove in the radial direction in order to ensure a freedom degree for the movement of the electric wiring. Further, the cross section of the first and second through holes can be arbitrarily formed into a circular shape, an elliptical shape, or the like. In addition, the cross-section of the accommodating groove may be assumed as a “U” shape. Besides, it is preferable that the accommodating groove extends to the image side end of the lens barrel.

Moreover, in the above configuration, the first through hole or the first accommodating groove and the second accommodating groove are provided in a manner such that a portion of the electric wiring arranged in the first through hole or the first accommodating groove and a portion of the electric wiring arranged in the second accommodating groove can be on a straight line in the optical axis direction. As a result, the electrical wiring can be extended in the form of a straight line without being bent, and the wiring path can be minimized in its length. Of course, it is also possible to further provide a second through hole in the side wall of the lens barrel in a manner such that it extends in the radial direction, in order to connect the first through hole or the first accommodating groove with the second accommodating groove.

Further, in the above configuration, when the lens barrel has two flanges, it is preferable that the first through hole or the first accommodating groove be provided to extend in a manner such that it can guide the electrical wiring to a position on the image side from the image side end portion of the flange which is closer to the image side than the other flange. This is because when the lens barrel has two flanges, if the first through hole or the first accommodating groove extends only to the image side end of the flange closer to the object side, as shown in FIG. 21 mentioned above, the presence of the flange closer to the image side will cause the electrical wiring to be largely exposed to the outside in the radial direction, hence hindering the assembly in which the flanges have been used.

Moreover, in the above configuration, it is also possible for the electrically functional component to be a planar heater for transferring a generated heat to the lens located closest to the object side in the lens group. In this case, examples of the planar heater include PTC (positive temperature coefficient) heater. The electrical resistance of the electrical wiring portion must be lower than that of the heater portion so that heat will not be generated at the wiring portion.

Further, in the above configuration, the electrical wiring may be a lead wire or a wiring made of FPC (Flexible printed circuits). In addition, it is also possible for the electric wiring to be a wiring pattern formed in the through holes and/or the accommodating grooves. Here, the formation of the wiring pattern may utilize a three-dimensional MID (Molded Interconnect Device), which is advantageous because a circuit can be formed on the surface of a compact and complicated molded body.

A lens unit according to another aspect of the present invention having: optical components such as a plurality of lenses and spacer arranged along an optical axis; a lens barrel accommodating and holding the optical components; and a planar heater capable of heating a first lens located closest to the object side,

wherein

the lens barrel has an accommodating/holding portion including an inner peripheral surface formed into a polygonal shape having an octagon or more, configured to accommodate and hold the optical components located closer to the image side than the first lens,

the planar heater includes a heating portion for heating the first lens and a belt-shaped extending portion extending from the heating portion to supply electricity to the heating portion,

the accommodating/holding portion is provided with an insertion groove extending in the axial direction of the lens barrel and having a groove width wider than the width of the extending portion,

the lens barrel is provided with a lead-out hole for leading out the extending portion inserted in the insertion groove to the outside, said lead-out hole being communicated with the insertion groove.

Here, in the lens barrel, a spacer may be provided between lenses mutually adjacent to each other in the optical axis direction, and the spacer may also be accommodated in the accommodating/holding portion. Therefore, in the present invention, optical component means a lens, a spacer, or the like.

Further, “polygon shape” means that the inner peripheral surface of the accommodating/holding portion is in a regular polygonal shape having an octagon or more in a plan view (axial view of the lens barrel), a polygonal shape other than regular polygon which is an octagon or more. It also includes a shape consisting of a combination of eight or more linear sides arranged at predetermined intervals in the circumferential direction and arcs arranged so as to connect sides adjacent to each other in the circumferential direction. Moreover, it also includes a shape having eight or more planes capable of supporting the outer circumference of the lens at several points (point contacts). By making the inner peripheral surface of the accommodating/holding portion a “regular polygonal shape”, it is possible to obtain an effect for lens axis alignment by uniform holding (equal stress distribution).

Moreover, as the planar heater, for example, it is possible to use an FPC heater or an organic PTC heater.

In the present invention, the accommodating holding portion for accommodating and holding optical components such as lenses and spacers is provided with an insertion groove extending in the axial direction of the lens barrel and having a groove width wider than the width of the extending portion. By inserting the extending portion into the insertion groove, the extending portion can be easily routed in the lens barrel. Further, since the lens barrel is provided with a lead-out hole for leading the extending portion (inserted in the insertion groove) to the outside and the lead-out hole is in communication with the insertion groove, it is possible for the extending portion (inserted in the insertion groove) to be easily taken out from the lead-out hole.

Moreover, since the extending portion of the planar heater does not interfere with the optical components, the optical components will not become eccentric (displaced) even if the extending portion is routed in the lens barrel.

Further, in the configuration of the present invention, it is also possible that the lead-out hole is provided on the peripheral wall of the lens barrel.

According to such a configuration, since the lead-out hole is provided on the peripheral wall of the lens barrel, it is possible for the extending portion of the planar heater to be easily led out from the peripheral wall of the lens barrel.

Further, in the configuration of the present invention, it is also possible that the lead-out hole is provided on the end face wall on the image side of the lens barrel.

According to such a configuration, since the lead-out hole is provided on the end face wall on the image side of the lens barrel, the extending portion of the planar heater can be easily led out from the end face wall of the lens barrel.

Further, in the configuration of the present invention, it is also possible that an angle formed between lines connecting both ends of the insertion groove in the width direction thereof and the center of the accommodating/holding portion is within 60°.

According to such a configuration, since the angle formed between lines connecting both ends of the insertion groove in the width direction thereof and the center of the accommodating/holding portion is within 60°, it is possible for the outer peripheral surface of the circular optical component to be held at six points or more in the accommodating/holding portion (whose inner peripheral surface has been formed into a polygonal shape of octagon or more). In this way, it is possible to stably hold the optical component lens.

Further, in the configuration of the present invention, it is also possible that the width of the insertion groove is within 3.5 mm.

According to such a configuration, since the groove width of the insertion groove is within 3.5 mm, it is possible for the extending portion of the planar heater (having a width within 3.5 mm) to be easily inserted into the insertion groove.

Further, in the configuration of the present invention, it is also possible that the planar heater includes a heating portion for heating the first lens, the heating portion is adhered to the end face of the first lens on the image side thereof using an adhesive.

Examples of the planar heater include an FPC heater and an organic PTC heater. Such a planar heater is formed in the shape of a donut plate and includes a heating portion for heating the first lens and a belt-shaped extending portion extending from the heating portion to supply electricity to the heating portion.

As an adhesive, it is preferable to use an epoxy resin which is an adhesive having an excellent thermal conductivity, or an epoxy resin containing a conductive filler, or the like.

According to such a configuration, since the heating portion of the planar heater is adhered to the end face of the first lens on the image side thereof (using an adhesive), even if the temperature of the lens unit changes depending on an environment (especially when the temperature becomes high) and thus a gap is formed between the lens barrel and the second lens or spacer accommodated and held within the lens barrel, since there is no gap formed between the first lens and the heating portion of the planer heater, there is no air to be interposed within the gap. As described above, since there is no air to be interposed, the thermal conductivity will not decrease, so that it is possible to stably and exactly heat the first lens by using the heating portion.

Further, in the configuration of the present invention, it is also possible that the first lens and the second lens or spacer are adjacent to each other in the optical axis direction and are in contact with each other,

a gap is provided between the first lens and the second lens or the spacer to accommodate the heating portion of the planar heater.

According to such a configuration, since it is possible to accommodate the heating portion of the planar heater in the gap, it becomes possible to easily arrange the heating portion.

Further, in the above-mentioned configuration of the present invention, it is also possible that the planar heater is an FPC heater or an organic PTC heater.

Further, in the configuration of the present invention, it is also possible that the planar heater is an organic PTC heater,

a gap is provided between the second lens or spacer adjacent to the first lens in the optical axis direction and the heating portion of the organic PTC heater.

When the heating portion of the organic PTC heater is pressurized in the thickness direction, the electric resistance will increase and PTC heater may be difficult to use.

On the other hand, according to the above configuration, since a gap is provided between the second lens or spacer adjacent to the first lens in the optical axis direction and the heating portion of the organic PTC heater. Therefore, the heating portion will not be pressed by being sandwiched between the first lens and a lens or spacer adjacent to the first lens in the optical axis direction. Accordingly, the organic PTC heater can be easily used.

Further, in the above-mentioned configuration of the present invention, it is also possible that the planar heater includes a belt-shaped extending portion extending from the heating portion and supplying electricity to the heating portion,

an insertion portion for inserting the extending portion of the planar heater along the axial direction of the lens barrel is provided on the outer peripheral portion of the second lens or the spacer adjacent to the first lens in the optical axis direction,

the lens barrel is provided with a lead-out hole for leading out the extending portion inserted in the insertion portion, said lead-out hole being communicated with the insertion portion.

Here, the insertion portion may be an insertion groove or an insertion hole provided in the outer peripheral portion of the second lens or the spacer adjacent to the first lens in the optical axis direction. In this case, it is preferable that the groove width of the insertion groove and the inner diameter of the insertion hole is wider than the width of the extending portion.

According to such a configuration, an insertion portion for inserting the extending portion of the planar heater along the axial direction of the lens barrel is provided in the outer peripheral portion of the second lens or spacer adjacent to the first lens in the optical axis direction. In this way, by inserting the extending portion into the insertion portion, the extending portion can be easily routed in the lens barrel. Further, since the lens barrel is provided with a lead-out hole for leading the extending portion (inserted in the insertion portion) to the outside and since such a lead-out hole is in communication with the insertion portion, it is possible to easily lead out the extending portion (inserted in the insertion portion) from the lead-out hole.

Further, in the above-mentioned configuration of the present invention, it is also possible that the adhesive is a thermosetting adhesive.

According to such a configuration, since the heating portion of the planar heater is adhered to the image-side end face of the first lens using a thermosetting adhesive, if a blackened portion is provided on the image-side end face of the first lens to prevent a ghosting phenomenon, it is possible to form an exact adhesion by using the thermosetting adhesive, even if the heating portion cannot be adhered to the image-side end face of the first lens using an UV-setting adhesive.

Further, in the configuration of the present invention, it is also possible that the planar heater is an FPC heater,

the FPC heater includes a heating portion for heating the first lens,

the heating portion has a plurality of circuit layers in which a circuit pattern has been formed by a metal foil.

Here, a copper foil is preferably used as a metal foil to form a circuit pattern, but it is also possible to use a foil formed by using one of other metals than copper, such as aluminum or SUS.

According to such a configuration, since the heating portion of the FPC heater has a plurality of circuit layers in which the circuit patterns have been formed by metal foil, it is possible to multiply the pattern length of each circuit pattern by several times. Thus, even in an FPC heater having a small-size heating portion, it is still possible to obtain a desired electric resistance, thereby obtaining a desired amount of generated heat.

Further, since it is not necessary to make the thickness of the metal foil (forming the circuit pattern) thinner or narrower than necessary, it is possible to obtain an effect that the electric resistance value is less likely to vary and a wiring disconnection is less likely to occur, thereby improving a reliability of the circuit pattern.

Further, in the configuration of the present invention, it is also possible that the circuit patterns respectively formed in the circuit layers of a plurality of layers are connected by a through hole.

According to such a configuration, since the circuit patterns formed in a plurality of circuit layers are connected via through holes, it is possible to easily increase the pattern length of the circuit pattern.

Further, in the configuration of the present invention, it is also possible that the lens unit has two circuit layers,

the heating portion has a donut plate-shaped base film,

the circuit layer is provided on both the front and back surfaces of the base film.

According to such a configuration, since the circuit layers are provided on both the front and back surfaces of the base film, it is possible to easily form a heating portion having two circuit layers, and it is also possible for the two circuit layers to be electrically insulated by virtue of the base film.

Further, the camera module of the present invention is characterized by including the lens unit.

According to such a configuration, it is possible to obtain the advantages effect of the lens unit with the camera module.

### Effects of the Invention

The lens unit and camera module of the present invention are provided such that its wiring guide portion provided in the side wall of the lens barrel for guiding the electrical wiring is divided into two portions (inside and outside portions with the flange serving as the boundary), a wiring guide portion extending closer to the object side than the flange is provided inside the lens barrel side wall as a through hole (first through hole) or a wiring accommodating groove (first accommodating groove), and another wiring guide portion extending closer to the image side than the flange is provided on the outside of the side wall of the barrel as a wiring accommodating groove (second accommodating groove). Accordingly, it is possible to guide the electrical wiring (extending from the electrically functional component provided in the lens barrel) without hindering the assembly work, without requiring a wiring space inside the lens barrel, and without having to form an elongated through hole in the lens barrel over almost the entire length thereof.

Further, it is possible to easily route the extending portion of the planar heater in the lens barrel, and to lead the extending portion to the outside.

### DESCRIPTION OF THE DRAWINGS

FIG. 1 is a schematic cross-sectional view of a lens unit according to a first embodiment of the present invention.

FIG. 2 shows how through holes and accommodating grooves can be formed when molding the lens barrel of FIG. 1 using a metal, wherein FIG. 2(a) is a top view of the lens barrel (object side plane view), FIG. 2 (b) is a side view of the lens barrel with a half cross section, FIG. 2(c) is a side view of the lens barrel, and FIG. 2 (d) is a bottom view (image side plane view) of the lens barrel.

FIG. 3 shows how through holes and accommodating grooves can be formed when molding the lens barrel of FIG. 1 using a resin, wherein FIG. 3(a) is a top view of the lens barrel (object side plane view), FIG. 3(b) is a side view of the lens barrel with a half cross section, FIG. 3(c) is a side view of the lens barrel, and FIG. 3 (d) is a bottom view (image side plane view) of the lens barrel.

FIG. 4 is a schematic cross-sectional view of a camera module including the lens unit shown in FIG. 1

FIG. 5 is a schematic cross-sectional view of a lens unit according to a first modification of the lens unit shown in FIG. 1.

FIG. 6 is a schematic cross-sectional view of a lens unit according to a second modification of the lens unit shown in FIG. 1.

FIG. 7 shows a second embodiment of the present invention, serving as a schematic cross-sectional view of a lens unit.

FIG. 8 (a) is a plan view showing a first example of the lens barrel, and FIG. 8(b) is a plan view showing a second embodiment of the lens barrel.

FIG. 9 is a perspective view of the lens barrel viewed from diagonally above.

FIG. 10 is another perspective view of the lens barrel, viewed from diagonally above.

FIG. 11 is a diagram schematically showing a state in which the lens is supported by an accommodating/holding portion.

FIG. 12 is a schematic cross-sectional view of the camera module.

FIG. 13 shows an FPC heater, FIG. 13 (a) is its front view and FIG. 13(b) is its back view.

FIG. 14 is a plan view showing a lens and a spacer.

FIG. 15 is a plan view showing a state in which the spacer is accommodated and held in the lens barrel.

FIG. 16 shows a third embodiment of the present invention, and is a schematic cross-sectional view of a lens unit.

FIG. 17 is a perspective view of a lens barrel as viewed from diagonally above.

FIG. 18 is a perspective view of the lens barrel viewed from diagonally below.

FIG. 19 shows a fourth embodiment of the present invention, serving as a schematic cross-sectional view of the lens unit.

FIG. 20 is a plan view of a spacer.

FIG. 21 is a partial vertical sectional view showing a generally conceivable arrangement of a lens unit provided with a heater and electrical wiring.

### DESCRIPTION OF EMBODIMENTS

Hereinafter, embodiments of the present invention will be described with reference to the accompanying drawings.

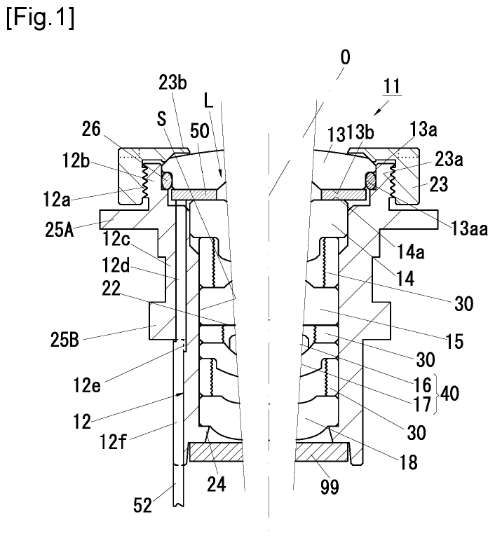

The lens unit of the present embodiment to be described below is particularly for use in a camera module such as an in-vehicle camera. For example, the lens unit is fixedly installed on the outer surface side of an automobile, and wiring is drawn into the automobile and connected to a display or other apparatuses. Further, in FIGS. 1, 4, 5, 7, 12, 16 and 19, hatching is omitted for a plurality of lenses.

### First Embodiment

FIG. 1 shows a lens unit 11 according to the first embodiment of the present invention. As shown in the figure, the lens unit 11 of the present embodiment includes, for example, a metal cylindrical lens barrel 12, and a plurality of lenses arranged in the inner accommodating space S of the lens barrel 12, as well as a diaphragm 22. The plurality of lenses are consisting of six lenses including a first lens 13, a second lens 14, a third lens 15, a fourth lens 16, a fifth lens 17, and a sixth lens 18, arranged from the object side. The lenses 13-18 and the diaphragm 22 are disposed partially via spacers 30 which separate the lenses 14, 15, 17, and 18 from each other in the optical axis direction.

Further, in the present embodiment, the diaphragm 22 is located between the third lens 15 and the spacer 30. The diaphragm 22 is serving as an “aperture ring” configured to limit an amount of transmitted light and determine an F value that is an index of brightness, or a “light shield ring” configured to block light rays that can cause ghosts and light rays that can cause an aberrations.

An in-vehicle camera having such a lens unit 11 includes a lens unit 11, a substrate having an image sensor (not shown), and an installation member (not shown) for installing the substrate in a vehicle such as an automobile.

The plurality of lenses 13, 14, 15, 16, 17, and 18 to be incorporated and held in the inner accommodating space S of the lens barrel 12, are stacked and arranged in a manner such that their respective optical axis are aligned with each other. The lenses 13, 14, 15, 16, 17, and 18 are arranged along one optical axis O to form a group of lenses L for use in image capturing. In this case, the fourth and fifth lenses 16, 17 located on the image side constitute a combined lens (bonded lens) 40. Further, the first lens 13 located on the most object side for partially constituting the lens group L is a spherical glass lens having a convex surface on the object side and a concave surface on the image side. Moreover, the third and fourth lenses 15, 16 constituting the combined lens 40 are also glass lenses, while other lenses 14, 17 are resin lenses. However, the present invention is not limited to such an embodiment. On the other hand, if necessary, the surfaces of the lenses 13, 14, 15, 16, 17, and 18 may be provided with an antireflection film, a hydrophilic film, a water-repellent film or the like.

A substantially cylindrical cap 23 serving as a fastening fixing member is screwed to the object side end portion 12b (upper end portion in FIG. 1) of the lens barrel 12, while the first lens 13 is fixed to the object side end portion 12b of the lens barrel 12 by virtue of the cap 23. Specifically, the cap 23 is so formed that its female screw portion 23a formed on the inner peripheral surface of the peripheral side wall thereof is screwed into the male screw portion 12a formed on the outer peripheral surface of the object side end portion 12b of the lens barrel 12. The radial inner peripheral edge 23b of the flange-shaped upper end is applied to the outer peripheral edge of the surface of the first lens 13 facing the object side, and the cap 23 is tightened so that the first lens 13 is fixed to the end portion 12b on the object side, thereby holding the lens group L along the optical axis direction in the lens barrel 12. If the lens barrel is made of resin, as will be described later, the first lens 13 may be fixed not by the cap 23, but by a caulking portion provided at the image side end of the lens barrel and caulked inward in the radial direction.

Further, an inner flange portion 24 with an opening having a diameter smaller than that of the sixth lens 18 is provided at the image-side end (lower end portion of FIG. 1) of the lens barrel 12. A plurality of lenses 13, 14, 15, 16, 17, 18 constituting the lens group L and the diaphragm 22 are disposed and held in the optical axis direction between the inner flange portion 24 and the cap 23.

Further, on the outer peripheral side surface 13a of the first lens 13 there is provided a stepped diameter-reduced portion 13aa having a smaller diameter on the image side portion of the lens 13. The diameter-reduced portion 13aa is provided with, for example, an O-ring 26 as a sealing member. The O-ring 26 is compressed in the radial direction between the outer peripheral side surface 13a of the first lens 13 and the inner peripheral surface of the object-side end 12b of the lens barrel 12, thereby forming a sealing between the object-side end 12b of the lens barrel 12 and the first lens 13. In this way, it is possible to prevent water and fine particles such as dust from entering the lens barrel 12 from the object-side end of the lens unit 11.

The outer peripheral side wall surface (hereinafter, simply referred to as side wall) 12c of the lens barrel 12 is provided with two flanges 25A, 25B protruding outward in the radial direction of the lens barrel 12 and can be used for attaching the lens unit 11 to other member. In this case, for example, a covering case or the like may be attached to the first flange 25A located on the object side, while the second flange 25B located on the image side is used for positioning when the lens barrel 12 is installed into the in-vehicle camera. By this positioning, it is possible to precisely control distances between the package sensor (capturing element; image sensor) 304 (which is located in an imaging position of the lens group L and will be described later) and the lenses 13, 14, 15, 16, 17, 18. Depending on the configuration on the camera side, it may be unnecessary to have two flanges, but is possible to use only the flange 25B when installing the lens barrel 12 into the in-vehicle camera body.

Further, in the present embodiment, an electrically functional component 50 is provided in the lens barrel 12 in a manner such that it is located closer to the object side than the flanges 25A, 25B. Particularly, in the present embodiment, the electrically functional component 50 is formed as a heater for transferring a generated heat to the first lens 13 located closest to the object side in the lens group L. Specifically, the electrically functional component 50 serving as a heater is interposed between the surface 13b (facing the image side) of the first lens 13 and the surface 14a (facing the object side) of the second lens 14 adjacent to the first lens 13, in a manner such that it is possible to warm the first lens 13 whose surface on the object side is exposed from the lens barrel 12 and is exposed to the outside environment. As a heater, it is possible to use, for example, PTC (positive temperature coefficient) heater.

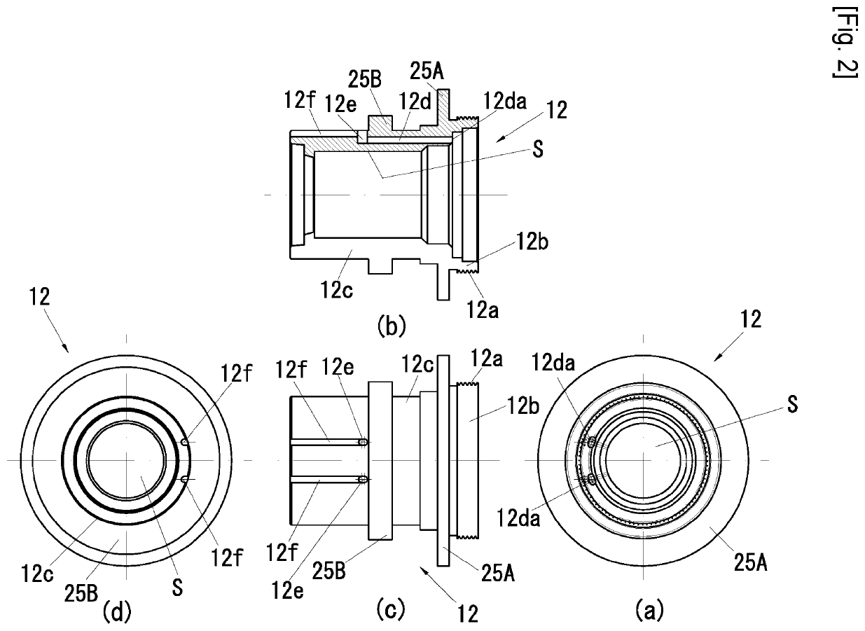

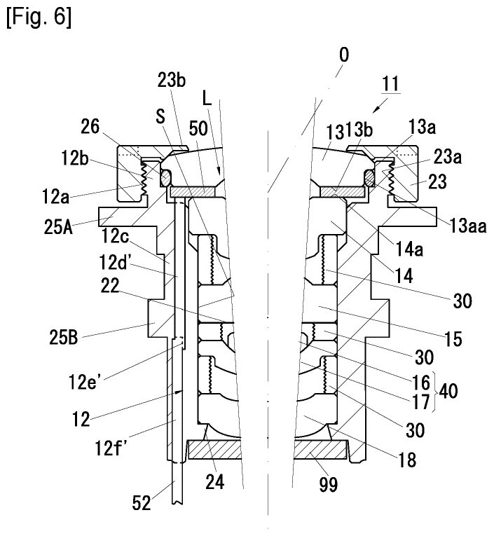

Further, the power supply to the electrically functional component 50 is realized by an electrical wiring, and in the present embodiment it is can be carried out by using the lead wire 52. Moreover, the lead wire 52 extending from the electrically functional component 50 is accommodated inside and outside the lens barrel 12, and is guided to the image side. Specifically, as clearly shown in FIG. 2, the lens barrel 12 is provided with: a first through hole 12d extending in the longitudinal direction of the cylinder 12 from the object side to the image side in the side wall 12c of the lens barrel 12 in order to guide the lead wire 52 to a position closer to the image side than the image side end of the second flange 25B (the flange closer to the image side); a second through hole 12e provided in the side wall 12c of the lens barrel 12 so as to extend in radial direction at the image side end of the second flange 25B, in a manner such that the first through hole 12d can communicate with the outside of the lens barrel 12; an accommodating groove 12f extending in the longitudinal direction of the lens barrel 12 from the object side toward the image side on the outer peripheral surface of the side wall 12c of the lens barrel 12 and communicating with the second through hole 12e, in order that the lead wire 52 led out from the second through hole 12e to the outside of the lens barrel 12 can be accommodated and guided to the image side (when the first accommodating groove is provided instead of the first through hole shown in FIG. 6 which will be described later, it is referred to as a second accommodating groove) (Namely, the second through hole 12e is provided to extend radially in the side wall 12c of the lens barrel 12, in order that the first through hole 112d and the accommodating groove 12f can be communicated with each other). Further, the position of the second through hole 12e is arranged along the object side surface of the second flange 25B, and the accommodating groove 12f is also continuous from the object side surface of the second flange 25B to the image side end face of the lens barrel 12. The position of the second through hole 12e and the object side end of the accommodating groove 12f do not have to coincide with the object side surface of the second flange 25B, but may be anywhere as long as it is closer to the image side than the object side surface of the flange 25B.

Further, particularly, in the present embodiment, the first and second through holes 12d, 12e, as well as accommodating grooves 12f are provided in parallel with each other, corresponding to the two lead wires 52 respectively connected to the plus (+) terminal and the minus (−) terminal of the electrically functional component 50. One end of each of the two lead wires 52 extending from the electrically functional component 50 is electrically connected to the electrically functional component 50 by, for example, soldering, while the other end thereof is at first led out to the outside of the lens barrel 12 through the first and second holes 12d, 12e, and then accommodated in the accommodating groove 12f and guided to be electrically connected to a power source (not shown) on the image side.

Moreover, in the present embodiment, the first through hole 12d and the accommodating groove 12f extend substantially parallel to the optical axis O in order to ensure the shortest distance. Further, as shown in FIG. 2(a), the object-side end portion of the first through hole 12d is formed as a long hole 12da in order to ensure a desired freedom degree of movement of the lead wire 52. Further, in the present embodiment, the accommodating groove 12f extends to the image-side edge of the lens barrel 12. The cross sections of the first and second through holes 12d, 12e can be arbitrarily set to have a circular shape, an elliptical shape, or the like. Further, the cross-section of the accommodating groove 12f may be any shape such as a “U” shape. Moreover, it is preferable that the width in the cross section of the accommodating groove 12f is substantially the same as the width of the lead wire 52 or a width that can be press-fitted in order to fix the lead wire 52.

Further, it is also possible to use a wiring configured by FPC (Flexible Printed Circuits) in the paired lead wires 52. In this case, the first and second through holes 12d, 12e are formed into one hole that can match the shape of the FPC.

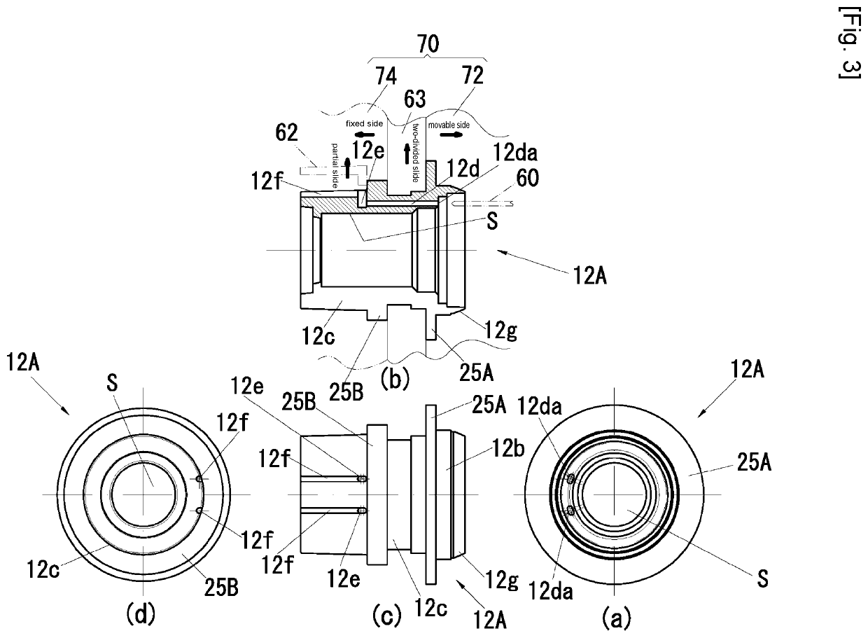

Further, in the present embodiment, since the lens barrel 12 is formed of metal, the first and second through holes 12d, 12e and the accommodating groove 12f may be formed in a cutting process using an endmill or the like. When the lens barrel is made of resin, as shown in FIG. 3, the first and second through holes 12d, 12e and the accommodating groove 12f may be formed by using a mold. Specifically, as schematically shown in FIG. 3(b), the resin lens barrel 12A may be formed into a substantially cylindrical shape by pouring a molten material into a mold 70. In the example of FIG. 3, the main body of the mold 70 is divided into two portions, with one being a fixed-side mold portion 74 (shown by a two-dot chain line in FIG. 3 (b)) and the other being a movable-side mold portion 72 (shown by a solid line in FIG. 3 (b)). A slidable insert for mold parts 63 (two-divided slide) for forming the portion of the side wall 12c between the first and second flanges 25A, 25B, and slidable insert pins 60, 62 (partial slides) for forming the through holes 12d, 12e and the accommodating groove 12f are provided separately from the mold bodies 72, 74. As a result, when the mold 70 is assembled, the fixed-side mold portion 74, the movable-side mold portion 70, and the insert for mold parts 63 can function together to define a cavity into which the molten material is poured. Meanwhile, the insert pins 60, 62 to be inserted into the cavity, are pulled out from the cavity after molding, thereby forming the first and second through holes 12d, 12e and the accommodating groove 12f. The first lens 13 is fixed to the resin lens barrel 12A not by the cap 23 but by a caulking portion 12g provided at the image side end portion of the lens barrel 12A and caulked inward in the radial direction.

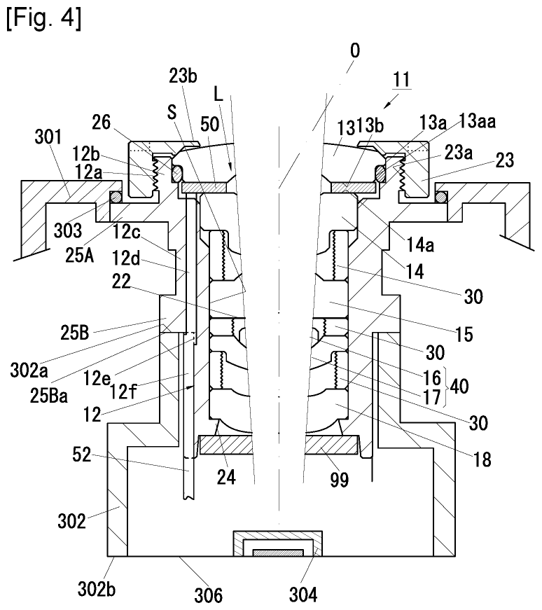

Further, FIG. 4 is a schematic cross-sectional view of the camera module 300 according to the present embodiment, including the lens unit 11 having a configuration shown in FIG. 1. As shown in the figure, the camera module 300 is formed by including a lens unit 11 of FIG. 1 in which a filter 99 is mounted.

The camera module 300 includes a front case (camera case) 301 which is an exterior component, and a mount (pedestal) 302 holding the lens unit 11. Further, the camera module 300 includes a seal member 3 and a package sensor 304 (capturing element; image sensor).

The front case 301 is connected to the first flange 25A through a sealing member (O-ring) 303, and serves as a member that exposes the end portion of the lens unit 11 on the object side and covers other portions to make them waterproof. The mount 302 is disposed inside the front case 301, and its object-side end 302a is in contact with and adhered to the image side surface 25Ba of the second flange 25B, with its image-side end 302b mounted and fixed on the substrate 306. Further, the seal member 303 is a member which is inserted between the inner surface of the front case 301 and the object side surface of the first flange 25A of the lens barrel 12, and is used for maintaining the airtightness inside the front case 301.

The package sensor 304 is disposed on the substrate 306 inside the mount 302, and is arranged at a position which receives an image of an object formed by the lens unit 11. Further, the package sensor 304 includes CCD, CMOS, or the like, and converts the light (that is focused and reaches through the lens unit 11) into an electric signal. The converted electrical signal is further converted into analog data or digital data (which are components of the image data captured by the camera).

As described above, in the present embodiment, for the purpose of guiding the lead wire 52 as electrical wiring, the wiring guide portions provided on the side wall 12c of the lens barrel 12 are divided into two portions (inside and outside), with the second flange 25B acting as a boundary. The wiring guide portion extending closer to the object side than the second flange 25B are provided inside the lens barrel side wall 12c as a through holes 12d, 12e, and another wiring guide portion extending closer to the image side than the second flange 25B is provided on the outside of the lens barrel side wall 12c as a wiring accommodating groove 12f. Accordingly, the lead wire 52 led out to the outside of the lens barrel 12 does not interfere with the assembly using the flanges 25A, 25B and it is not necessary to ensure a wiring space within the lens barrel 12. Further, since the accommodating portion 12f of the lead wire 52 led out to the outside of the lens barrel 12 is formed into a groove shape, it is not necessary to increase the outer diameter of the lens barrel 12.

Further, in the present embodiment, since the formation of the through holes 12d, 12e in the lens barrel side wall 12c is restricted closer to the object side than the second flange 25B, it is not necessary to form an elongated through hole over almost the entire length of the lens barrel 12. Therefore, it becomes possible to avoid a breakage of the above-mentioned endmill (which is a concern when forming such a through hole in the metal lens barrel 12), it is also possible to avoid the tilting and breaking of the above-mentioned insert pin, which is a concern when such a through hole is formed during the molding of the resin lens barrel 12A. Alternatively, it becomes possible to avoid a complexity of the mold structure, thereby making it possible to realize an industrial mass production.

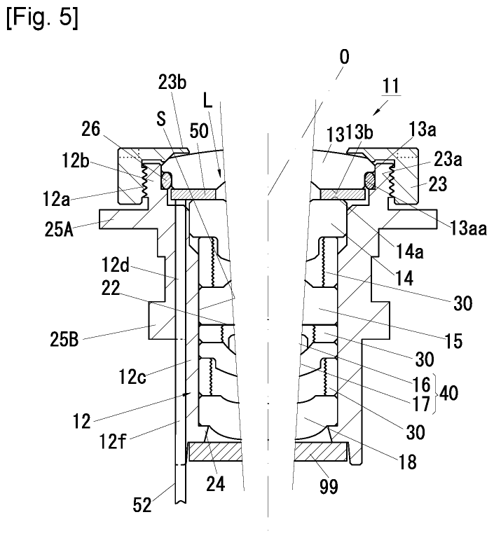

The present invention is not limited to the above-described embodiment, and can be variously modified and implemented without departing from the gist thereof. For example, in the above-described embodiment, the electrical wiring is a lead wire, but the electrical wiring may also be a wiring made of FPC (Flexible Printed Circuits), and further, wiring pattern may be formed in the through hole and/or the accommodating groove (the same applies to FIGS. 5, 6 which will be described later). Further, in forming the wiring pattern, it is also possible to use a three-dimensional MID (Molded Interconnect Device). Moreover, in the above-described embodiment, the electrically functional component is a heater, but the electrically functional component may also be any component as long as it can provide some electrical functions. When the electrically functional component is a heater, the electrical resistance of the electrical wiring portion must be lower than that of the heater section, so that heat is not generated at the wiring portion.

Although in the above-described embodiment, the second through hole 12e is provided, it is also possible for the first through hole 12d to be opened on the image side surface of the second flange 25B and communicated as such with the accommodating groove 12f on the outer surface of the lens barrel side wall 12c in the optical axis direction, without providing the second through hole 12e (as shown in FIG. 5). In this case, the first through hole 12d and the accommodating groove 12f are provided in a manner such that the portion of the electric wiring 52 arranged in the first through hole 12d and the portion of the electric wiring 52 arranged in the accommodating groove 12f can be arranged along a straight line in the optical axis direction. Further, in the above-described embodiment, the wiring guide portion extending in the longitudinal direction of the lens barrel is formed as the first through hole (through hole penetrating the side wall 12c of the lens barrel) on the object side of the second flange 25B. On the other hand, it is also possible for such a wiring guide portion to be an accommodating groove (first accommodating groove) 12d, as shown in FIG. 6. In particular, in the structural form of FIG. 6, the above-mentioned accommodating groove extending in the longitudinal direction on the image side of the second flange 25B is formed on the inner surface of the lens barrel side wall 12c instead of the outer surface. Namely, the structural form of FIG. 6 includes a first accommodating groove 12d′, a second accommodating groove 12f′, and a radial direction groove 12e′. a first accommodating groove 12d is provided to be opened towards the inner accommodating space S of the lens barrel 12 in a manner such that it extends in the longitudinal direction from the object side to the image side in the inner surface of the lens barrel side wall 12c in order to guide the lead wire 52 to a position closer to the image side than the image side end of the second flange 25B. The second accommodating groove 12f′ is provided to be opened towards the inner accommodating space S of the lens barrel 12 in a manner such that it extends in the longitudinal direction from the object side to the image side in the inner surface of the lens barrel side wall 12c at the position closer to the image side than the second flange 25B. The radial direction groove 12e′ extends in the radial direction of the lens barrel side wall 12c in a manner such that the first accommodating groove 12d′ and the second accommodating groove 12f′ can be connected to each other. By virtue of the afore-mentioned first and second accommodating grooves 12d′, 12f′ and the radial direction groove 12e′, the electrical wiring 52 extends only over the inner surface of the lens barrel side wall 12c (along the lens barrel side wall 12c in the inner accommodating space S of the lens barrel 12). In the figure, the radial direction groove 12e′ extends radially outward from the image side end of the first accommodating groove 12d′ and is connected to the object side end of the second accommodating groove 12f′. On the other hand, instead of such an arrangement, it is also possible for the radial direction groove 12er to extend radially inward from the image side end of the first accommodating groove 12d′ and to be connected to the object side end of the second accommodating groove 12f′. In addition, it is further possible to omit the radial direction groove 12e′, and allow the first accommodating groove 12d′ and the second accommodating groove 12f′ to be positioned in a straight line with each other and communicate with each other.

### Second Embodiment

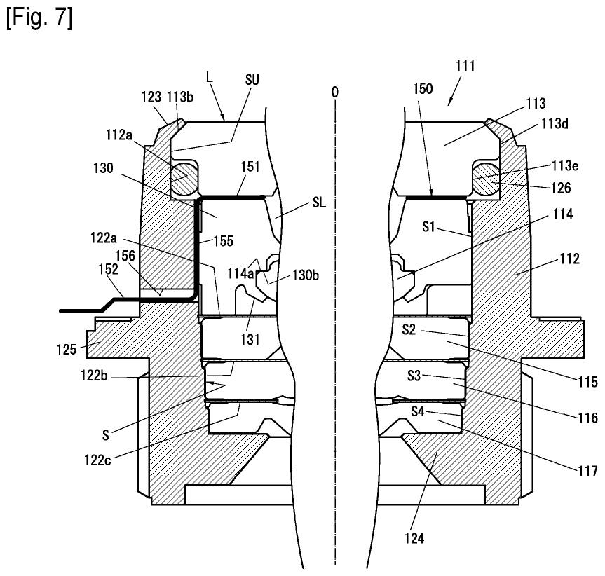

FIG. 7 shows a lens unit 111 according to the second embodiment of the present invention. As shown in the figure, the lens unit 111 of the present embodiment includes, for example, a cylindrical resin lens barrel 112 and a plurality of plane-viewing circular lenses and three diaphragms 122a, 122b, 122c arranged in the lens barrel 112. The plurality of lenses are, for example, consisting of five lenses including a first lens 113, a second lens 114, a third lens 115, a fourth lens 116, and a fifth lens 117, arranged from the object side (upper side in FIG. 7).

Further, the bottom surface of the lens barrel 112 is provided with a groove extending in the radial direction from the inner circumference of the bottom surface of the lens barrel 112 toward a portion not in contact with the lens 117. This groove is provided for air to flow for airtightness check.

In the present embodiment, the first lens 113, the second lens 114, the third lens 115, the fourth lens 116, the fifth lens 117, the diaphragms 122a, 122b, 122c, and the spacer 130 (which will be described later) are referred to as optical components.

The first diaphragm 122a from the object side of the three diaphragms 122a, 122b, 122c is arranged between the second lens 114 and the third lens 115. The second diaphragm 122b from the object side is arranged between the third lens 115 and the fourth lens 116. The third diaphragm 122c from the object side is arranged between the fourth lens 116 and the fifth lens 117.

The diaphragm 122a is an “aperture ring” that limits an amount of transmitted light and determines an F value that is an index of brightness. Further, the diaphragm 122b, 122c are “light shield ring” that block light rays which cause ghosts and light rays which cause aberrations. An in-vehicle camera having such a lens unit 111 includes a lens unit 111, a substrate having an image sensor (not shown), and an installation member (not shown) for installing the substrate in a vehicle such as an automobile.

A plurality of lenses 113, 114, 115, 116, 117 housed in the lens barrel 112 are stacked and arranged in a state where their respective optical axis are aligned with each other, and respective lenses 113, 114, 115, 116, 117 are arranged side by side along one optical axis O to form a lens groups L for use in image capturing. In this case, the first lens 113 located closest to the object side and partially constituting the lens group L is a spherical glass lens having a flat surface on the object side and a concave surface on the image side, and the second lens 114 is also a spherical glass lens having a convex curved surface on each side (object side and the image side). Other lenses 115, 116, 117 are resin lenses, but are not limited thereto (for example, the first lens 113 and the second lens 114 may be resin lenses. If resin is used to form these lenses, the first lens 113 and the second lens 114 may have, for example, a difference in their linear expansion coefficients between them which may be 40×10⁻⁶/K (m) or more).

Further, the lens barrel 112 is provided with a spacer 130 between the first lens 113 and the third lens 115, and an inter-lens space SL is formed which is surrounded by the first lens 113, the third lens 115, the spacer 130, and the second lens 114. The first lens 113 and the spacer 130, the spacer 130 and the third lens 115 may be adhered to each other, so that the inside of the inter-lens space SL is sealed to the outside. The number of lenses, the number of spacers, the materials of the lenses, spacers and lens barrels and the like can be arbitrarily set according to an intended use.

Further, if necessary, surfaces of these lenses 113, 114, 115, 116, 117 may be provided with an antireflection film, a hydrophilic film, a water repellent film or the like.

The spacer 130 is formed in a cylindrical shape, and the second lens 114 is held at the inner lower end thereof. Namely, the spacer 130 has a caulking portion 131 at the lower edge thereof on the inner diameter side. The caulking portion 131 is thermally caulked inward in the radial direction so as to press the facing surface 114a of the second lens 114 against the facing surface 130b of the spacer 130 in the optical axis direction.

In this way, the facing surface 114a of the second lens 114 is pressed against the facing surface 130b of the spacer 130 by the caulking portion 131, so that the second lens 114 is held by the spacer 130.

Further, in the present embodiment, an O-ring 126 serving as a sealing member is interposed between the first lens 113 located closest to the object and the lens barrel 112, so that water and dust may be prevented from entering the lens group L inside the lens barrel 112. In this case, a stepped diameter-reduced portion 113e having a smaller diameter at the image-side portion of the lens 113 is provided on the outer peripheral surface 113d of the first lens 113, and an O-ring 126 is attached to the diameter-reduced portion 113e. The O-ring 126 is radially compressed between the outer peripheral surface 113d of the first lens 113 and the inner peripheral surface 112a of the lens barrel 112, so that the end of the lens barrel 112 on the object side is sealed.

The sealing member inserted between the first lens 113 and the lens barrel 112 is not limited to the O-ring 126. In fact, it is possible to use a sealing member of any type, provided it is an annular member capable of providing a sealing effect between the first lens 113 and the lens barrel 112.

Further, with the lens group L incorporated and held in the lens barrel 112, the caulking portion 123 at the barrel end portion (upper end portion in FIG. 7) on the object side is thermally caulked inwardly in the radial direction. In this way, the first lens 113 located closest to the object side of the lens group L may be fixed in the optical axis direction to the object side end of the lens barrel 112 by virtue of the caulking portion 123. In this case, the portion of the glass lens 113 to which the caulking portion 123 is to be pressure-welded is formed as a flat portion 113b cut diagonally into a plane, thereby ensuring a stabilized caulking.

Further, the lens barrel 112 has an inner flange portion 124 having an opening with a diameter smaller than that of the fifth lens 117 at image side end portion (lower end portion in FIG. 7). The inner flange portion 124 and the caulking portion 123 hold and fix the plurality of lenses 113, 114, 115, 116, 117 and the diaphragm 122a, 122b, 122c (constituting the lens group L) in the optical axis direction within the lens barrel 112.

The lens barrel 112 includes an accommodating/holding portion S for accommodating and holding optical components such as the lenses 115, 116, 117 and a spacer 130 provided between the lenses 113, 115 adjacent to each other in the optical axis direction.

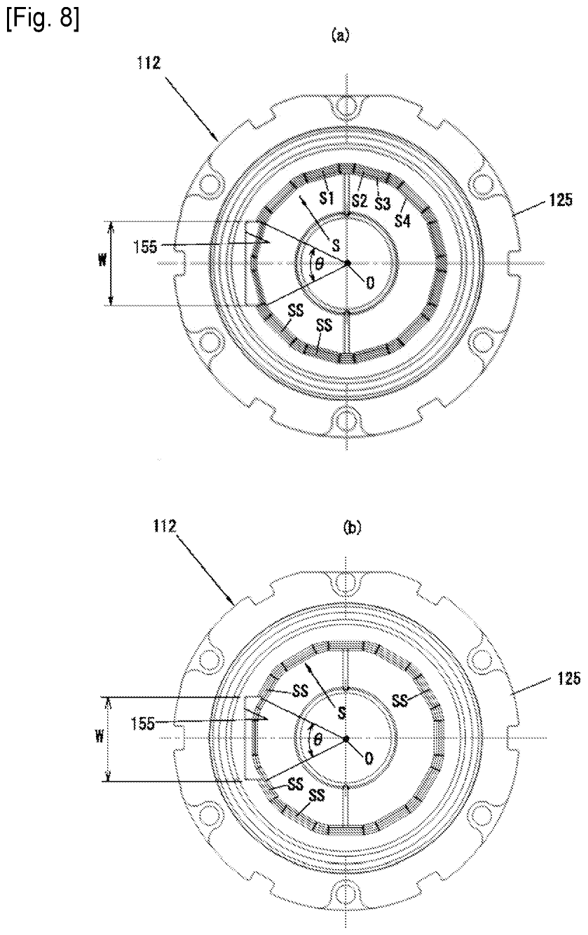

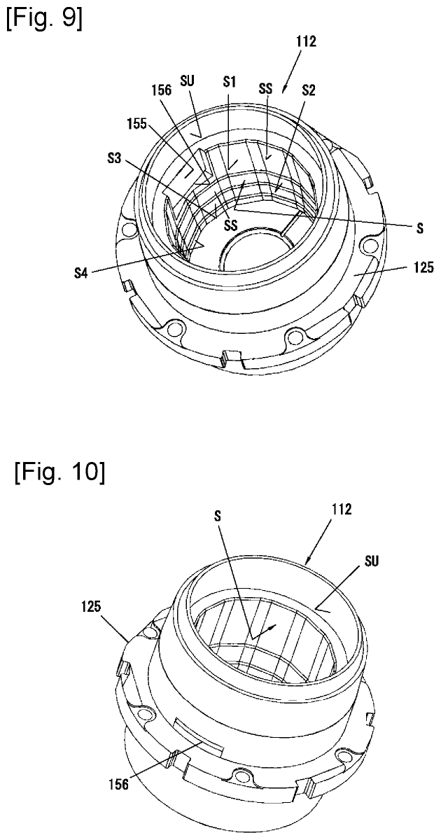

As shown in FIG. 8 and FIG. 9, the accommodating/holding portion S has an inner peripheral surface formed in a polygonal shape having an octagon or more. In the present embodiment, the accommodating/holding portion is configured by combining twelve straight sides (strings) arranged at predetermined intervals in the circumferential direction, and twelve arcs arranged to connect adjacent sides (strings) in the circumferential direction.

Further, the inner diameter of the accommodating/holding portion S is gradually reduced from the object side to the image side. Correspondingly, the outer diameters of the spacer 130 and the lenses 115, 116, 117 become smaller from the object side toward the image side. Basically, the outer diameters of the spacer 130 and the lenses 115, 116, 117, are substantially equal to the inner diameters of portions of the accommodating/holding portion S of the lens barrel 112 supporting the spacer 130 and the lenses 115, 116, 117.

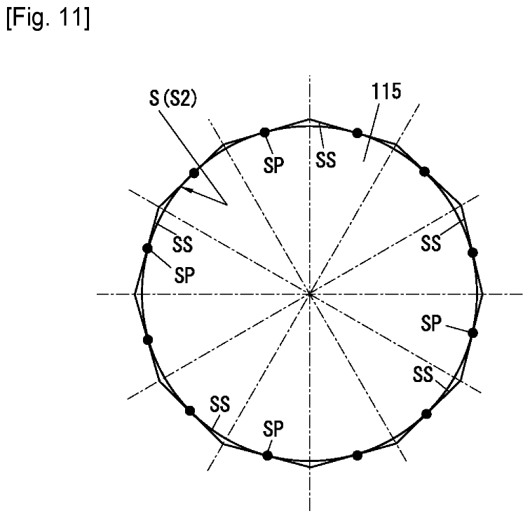

Namely, if the lens 115 is described as a representative, as schematically shown in FIG. 11, the accommodating/holding portion S has twelve planar support surfaces SS by forming the inner peripheral surface into a regular dodecagonal shape, and these twelve support surface SSs are adjacent to each other at the same angle in the circumferential direction. The central portion of each support surface SS in the circumferential direction is a support point SP that supports the outer peripheral surface of the lens 115, and there are twelve such support points SP. Therefore, the lens 115 may be stably supported by the twelve support points SP in the direction orthogonal to the optical axis.

In FIG. 8, as described above, there has been shown a combination including twelve straight sides (strings) arranged at predetermined intervals in the circumferential direction, and twelve arcs arranged to connect adjacent sides (strings) in the circumferential direction. The following description will be given to explain a regular dodecagonal shape.

Similarly, the inner peripheral surface of the accommodating/holding portion S for accommodating and holding the spacer 130 and the lenses 116, 117 is formed into a regular dodecagonal shape, but the outer diameter thereof gradually decreases from the object side to the image side (which is a distance between the support points SP arranged point-symmetrically with the optical axis as the center). Further, the lenses 116, 117 are also stably supported by twelve support points SP in the direction orthogonal to the optical axis. On the other hand, as described later, since an insertion groove 155 is provided in the accommodating/holding portion S, the spacer 130 can be stably supported by ten support points SP in the direction orthogonal to the optical axis.

Here, as shown in FIGS. 7-9, the accommodating/holding portion S comprises a first accommodating/holding portion S1 for accommodating and holding the spacer 130, a second accommodating/holding portion S2 for accommodating the lens 115, a third accommodating/holding portion S3 for accommodating and holding the lens 116, and a fourth accommodating/holding portion S4 for accommodating the lens 117, with the inner diameters thereof being gradually smaller from the first accommodating/holding portion S1 to the fourth accommodating/holding portion S4. Further, a stepped surface is provided between the accommodating/holding portions adjacent to each other in the axial direction of the lens barrel 112 so as to project inward in the radial direction.

Further, the accommodating/holding portion S shown in FIG. 8 (a) is arranged so that one apex of the regular dodecagon is directed toward the center in the width direction of the insertion groove 155 (which will be described later). In contrast, the accommodating/holding portion S shown in FIG. 8 (b) is arranged toward a position where one apex of the regular dodecagon is rotated by 15° in the circumferential direction from the center of the insertion groove 155 in the width direction. Anyway, the spacer 130 is supported by ten support points SP.

Further, the accommodating/holding portion SU accommodating the first lens 113 closest to the object side has an inner peripheral surface formed in a circular shape, and the accommodating holding portion SU accommodates and holds the first lens 113.

Further, the second lens 114 is formed to have a smaller diameter than the lenses 113, 115, 116, 117, and is held and fixed to the spacer 130.

On the outer peripheral surface of the lens barrel 112 there is provided an outer flange portion 125 in a flange shape for use in attaching the lens barrel 112 to an in-vehicle camera.

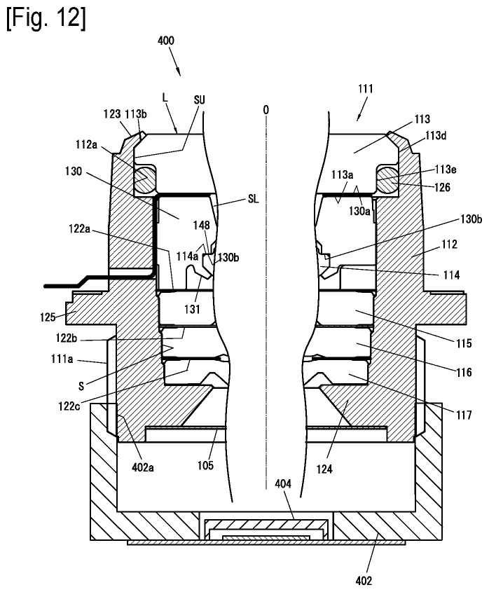

FIG. 12 is a schematic cross-sectional view of the camera module 400 of the present embodiment having the lens unit 111 shown in FIG. 7. As shown in the figure, the camera module 400 includes a lens unit 111 to which the filter 105 is mounted.

The camera module 400 includes an upper case (not shown) which is an exterior component, and a mount (pedestal) 402 for holding the lens unit 111. Further, the camera module 400 includes a package sensor (capturing sensor) 404.

The upper case is a member that exposes the end of the lens unit 111 on the object side and covers other parts. The mount 402 is arranged inside the upper case and has a female screw 402a that can be screwed with the male screw 111a of the lens unit 111.

The package sensor 404 is arranged inside the mount 402 and is arranged at a position which receives an image of an object formed by the lens unit 111. Further, the package sensor 304 includes CCD, CMOS or the like, and converts the light (that is focused and arrives here through the lens unit 111) into an electric signal. The converted electrical signal is then converted into analog data or digital data which are components of the image data captured by the camera.

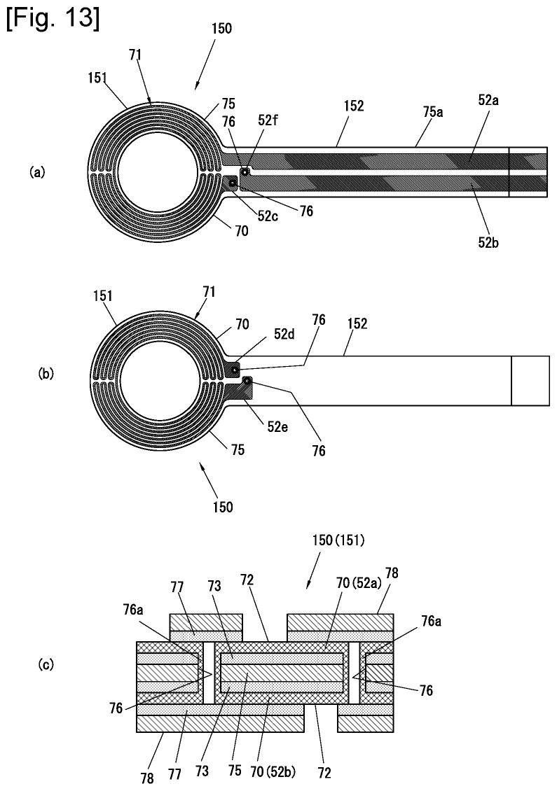

As shown in FIG. 7 and FIG. 13, the lens unit 111 and the camera module 300 having the above configuration include an FPC heater (planar heater) 150 capable of heating the first lens 113 located closest to the object side. On the other hand, it is also possible to use an organic PTC heater as the planar heater.

As shown in FIG. 13, the FPC heater 150 is formed of a flexible printed circuit board, and has a heating portion 151 for heating the first lens 113 and also has an extending portion 152 extending from the heating portion 151 to supply electricity to the heating portion 151. FIG. 13 (a) is a front view of the FPC heater 150, FIG. 13 (b) is a back view of the FPC heater 150, and FIG. 13 (c) is a diagram schematically showing the cross section of the FPC heater 150.

The heating portion 151 is formed in a donut plate shape, its outer diameter is substantially equal to the outer diameter of the end face 113a of the first lens 113 on the image side thereof, and its inner diameter is almost equal to the inner diameter of the end face 113a of the first lens 113 on the image side thereof.

Further, as shown in FIG. 13(c), the heating portion 151 has two circuit layers 72 in which the circuit pattern 71 formed by the copper foil 70 (see FIGS. 13(a) and 13(b)) has been formed. On the other hand, instead of the copper foil 70, it is also possible for the circuit pattern 71 to be formed of aluminum foil or SUS.

Moreover, the heating portion 151 has a donut plate-shaped base film 75 in the central portion in the thickness direction. The base film 75 is formed of a polyimide film. The polyimide film has a very high strength, an excellent heat resistance, and an excellent electrical insulation.

The circuit layers 72 are provided on both the front and back surfaces of the base film 75. Namely, the base film 75 is provided with adhesive layers 73 on both of its front and back surfaces, and the circuit layers 72, 72 are provided on the surfaces of the adhesive layers 73, 73, respectively. The adhesive layer 73 and the adhesive layer 77 (which will be described later) are formed of a thermosetting resin such as epoxy resin, silicone resin, an urea resin.

The base film 75 and the adhesive layers 73, 73 form an insulating layer, and through hole 76 is provided in the insulating layer penetrating the insulating layer in the thickness direction. A copper-plated film 76a is provided on the inner surface of the through hole 76, and the circuit patterns 71, 71 of the circuit layers 72, 72 are electrically connected by the copper-plated film 76a. Two through holes 76 are provided, and the circuit patterns 71, 71 are provided such that their end portions are connected to each other at the end of the extending portion 152 on the heating portion 151.

Further, adhesive layers 77, 77 are provided on the surfaces of the circuit layers 72, 72, and cover films 78, 78 are provided on the surfaces of the adhesive layers 77, 77. The cover film 78 is formed of a polyimide film like the base film 75.

As shown in FIG. 13 (a) and FIG. 13 (b), the circuit pattern 71 is formed by forming the circuit portion line-symmetrically on the donut plate-shaped base film 75. The circuit portion formed in a semicircular shape while the thin wire copper foil 70 is folded back towards the inner peripheral side from the outer peripheral side so as to form a semicircular arc, and this circuit portion generates a heat.

The circuit pattern 71 may be formed by a well-known etching process, or may be formed by an inkjet printer using a micro-piezo technique.

The extending portion 152 extends radially outward from the heating portion 151, and is formed by arranging two belt-shaped copper foils 52a, 52b in parallel on the surface of the belt-shaped base film 75a. One of the copper foils 52a, 52b is connected to the anode of the power supply and the other is connected to the cathode.

The base film 75a is integrally formed with the base film 75 of the heating portion 151.

Further, the layer structure of the extending portion 152 is the same as the layer structure of the heating portion 151. Therefore, cover films are provided on the surfaces of the copper foils 52a, 52b via the adhesive layer.

Further, the base end portion of the extending portion 152 is formed such that its copper foils 52a, 52b are exposed, the exposed portions are connected to the power supply.

As shown in FIG. 13(a), the copper foil 52a is connected to one end of the circuit pattern 71 on the surface side of the extending portion 152, a connecting portion 52c made of copper foil is connected to the other end of the circuit pattern 71.

As shown in FIG. 13 (b), on the back surface of the extending portion 152, connecting portion 52d is formed of a copper foil facing the connecting portion 52c on the front surface side in the thickness direction, and the connecting portion 52c is connected with the connecting portion 52d. The connecting portion 52c and the connecting portion 52d are connected by the through hole 76.

The connecting portion 52d is connected to one end of the circuit pattern 71 on the back surface side thereof, and the connecting portion 52e formed of copper foil is connected to the other end of the circuit pattern 71.

As shown in FIG. 13(a), on the front surface of the extending portion 152, the connecting portion 52f is formed of a copper foil facing the connecting portion 52e on the back surface side in the thickness direction, and the connecting portion 52f is connected with the connecting portion 52e. The connecting portion 52e and the connecting portion 52f are connected together via the through hole 76. As a result, regarding the extending portion 152, the circuit pattern 71 on the front surface side thereof and the circuit pattern 71 on the back surface side thereof may be connected together.

Therefore, by connecting one of the copper foils 52a, 52b to the anode of the power supply and connecting the other of them to the cathode, electricity may be supplied to the circuit patterns 71, 71 on both the front surface and back surface, so that the circuit patterns 71, 71 can generate heat.

As shown in FIG. 8 and FIG. 9, the accommodating/holding portion S is provided with an insertion groove 155 extending in the axial direction of the lens barrel 112. The insertion groove 155 has a groove width wider than the width of the extending portion 152 of the FPC heater 150 and a groove depth deeper than the thickness of the extending portion 152. Further, the insertion groove 155 extends from the end of the first accommodating/holding portion S1 on the object side thereof to a position on the object side slightly beyond the end of the first accommodating/holding portion S1 on the image side thereof.

The heating portion 151 of the FPC heater 150 is in close contact with the end face 113a on the image side of the lens 113, and the extending portion 152 is directed to the insertion groove 155 side and then inserted into the insertion groove 155.

Further, a lead-out hole 156 is provided in the peripheral wall of the lens barrel 112 in a manner such that it can communicate with the insertion groove 155. Moreover, the lead-out hole 156 is a rectangular hole, and the hole width is equal to the groove width of the insertion groove 155. Here, the lead-out hole 156 is formed in a manner such that it can penetrate the peripheral wall of the lens barrel 112. The outlet of the lead-out hole 156 is arranged on the peripheral wall of the lens barrel 112 above the outer flange portion 125. On the other hand, the lead-out hole 156 may also be provided below the outer flange portion 125 (on the image side), and such an outlet of the lead-out hole 156 may be arranged on the peripheral wall of the lens barrel 112 below the outer flange portion 125.

Such a lead-out hole 156 is provided for leading the extending portion 152 of the FPC heater 150 (inserted in the insertion groove 155) to the outside of the lens barrel 112, while the extending portion 152 inserted in the insertion groove 155, after being bent radially outward at a substantially right angle at the inlet of the lead-out hole 156, is inserted into the lead-out hole 156 and then led out to the outside.

Further, in the present embodiment, as shown in FIG. 8, the angle θ formed between lines connecting both ends of the insertion groove 155 in the width direction thereof and the center of the accommodating/holding portion S (first accommodating/holding portion S1) is within 60°

As shown in FIG. 8(a), the inner peripheral surface of the first accommodating/holding portion S1 is formed into a regular polygonal shape having a regular dodecagon or more, but by cutting out a part of the inner peripheral surface in the shape of a rectangular groove shape, two support surfaces SS of the twelve support surfaces SS are cut off. Therefore, the spacer 130 is supported by ten support points SP. Accordingly, even if the insertion groove 155 is formed, it is still possible to stably support the spacer 130.

Further, as shown in FIG. 8(b), the inner peripheral surface of the first accommodating/holding portion S1 is formed into a regular polygonal shape having a regular dodecagon or more, but by cutting out a part of the inner peripheral surface in the shape of a rectangular groove shape, one support surface SS and half or less of two support surfaces SS of the twelve support surfaces SS are cut off. Therefore, the spacer 130 is supported by 10 support points SP. In this way, even if the insertion groove 155 is formed, the spacer 130 can still be stably supported.

As shown in FIG. 14, the lenses 115-117 and the spacer 130 are provided in a manner such that their outer diameter portions are formed into cylindrical surfaces, but a flat surface 130a may be formed on part of the cylindrical surfaces to form a D-cut. Preferably, D-cut portion having a D-cut shape is arranged to face the insertion groove 155. The same applies to the third embodiment of the present invention which will be described later.

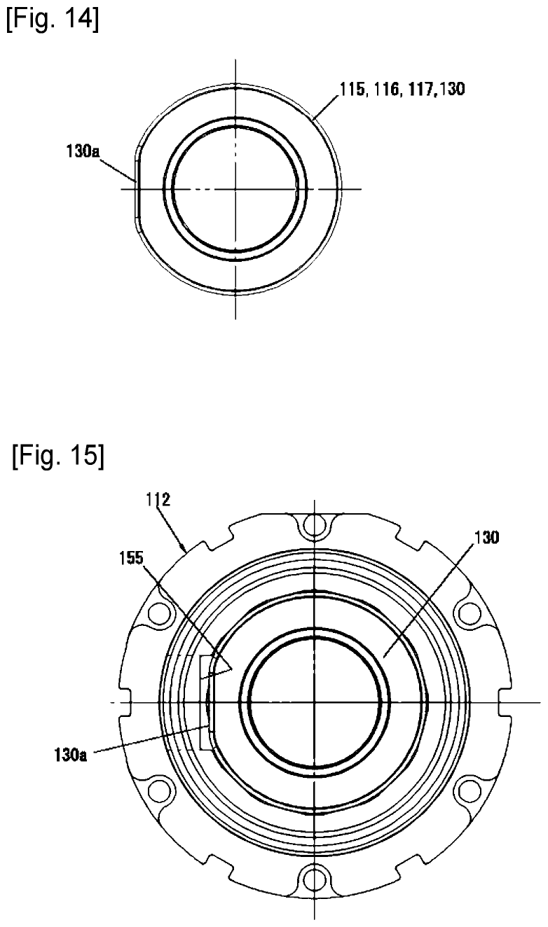

The flat surface 130a is a portion that serves as a gate when molding the lenses 115-117 and the spacer 130. the flat surface 130a is originally a portion that does not abut on the support surface SS of the first accommodating/holding portion S1. Therefore, as shown in FIG. 15, by arranging the flat surface 130a in the insertion groove 155, the spacer 130 can be supported by ten support points SP.

On the other hand, it should be noted that there is a sufficient gap between the flat surface 130a arranged in the insertion groove 155 and the groove bottom surface of the insertion groove 155, allowing an insertion of the extending portion 152 of the FPC heater 150.

Further, in the present embodiment, as shown in FIG. 8, the groove width W of the insertion groove 155 is within 3.5 mm. As described above, when the groove width of the insertion groove 155 is set to an angle θ of 60° or less, a larger outer diameter of the spacer 130 will result in a larger groove width of the insertion groove 155. Accordingly, in order to inhibit an over-increased size, the groove width W of the insertion groove 155 should be set at 3.5 mm or less.

As described above, according to the present embodiment, the first accommodating/holding portion S1 is provided with an insertion groove 155 extending in the axial direction of the lens barrel 112 and having a groove width wider than the width of the extending portion 152 of the FPC heater. In this way, by inserting the extending portion 152 into the insertion groove 155, the extending portion 152 can be easily routed in the lens barrel. Further, a lead-out hole 156 for leading the extending portion 152 (inserted in the insertion groove 155) to the outside is provided on the peripheral wall of the lens barrel 112 so as to communicate with the insertion groove 155. Accordingly, the extending portion 152 inserted into the insertion groove 155 can be easily led out from the lead-out hole 156.

Further, since the extending portion 152 of the FPC heater 150 does not interfere with the spacer 130 and the lenses 115, 116, 117, even if the extending portion 152 is routed in the lens barrel 112, the spacer 130 and the lenses 115, 116, 117 will not become eccentric.

Moreover, since lead-out hole 156 is provided on the peripheral wall of the lens barrel 122, the extending portion 152 of the FPC heater 150 can be easily led out from the peripheral wall of the lens barrel 112.

Further, since an angle formed between lines connecting both ends of the insertion groove 155 and the center of the accommodating/holding portion S1 is within 60°, the outer peripheral surface of the spacer 130 can be held by 10 support points SP in the first accommodating/holding portion S1 whose inner peripheral surface is formed into a regular dodecagon. Therefore, the spacer 130 can be stably held.

In addition, since the groove width of the insertion groove 155 is within 3.5 mm, the extending portion 152 of the FPC heater 150 having the width within 3.5 mm can be easily inserted into the insertion groove 155.

### Third Embodiment

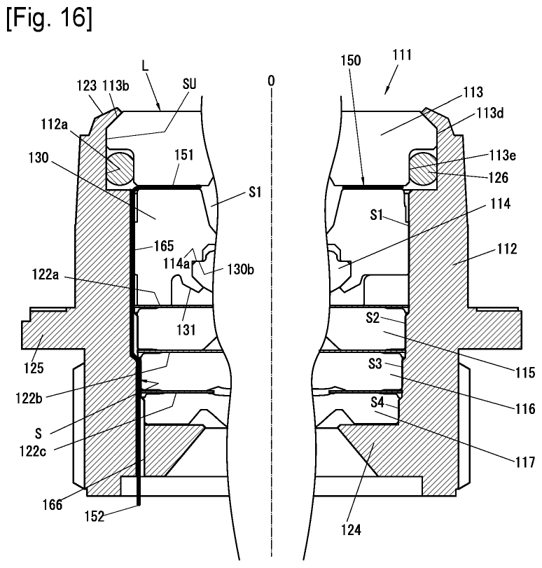

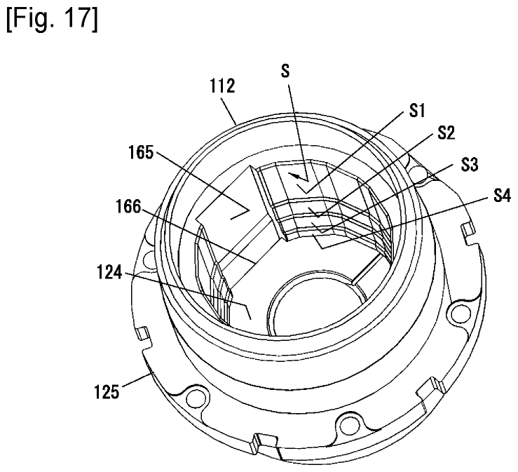

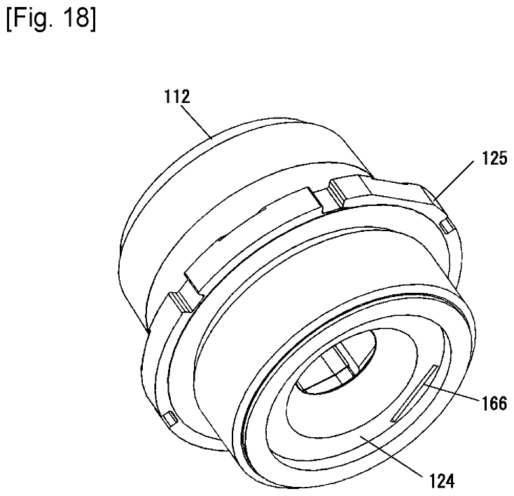

FIGS. 16-18 show a third embodiment of the present invention. FIG. 16 is a cross-sectional view of the lens unit 111, FIG. 17 is a perspective view of the lens barrel 112 viewed obliquely from above, and FIG. 18 is a perspective view of the lens barrel 112 viewed obliquely from below. The difference between the lens unit 111 of the third embodiment and the lens unit 111 of the second embodiment is in the configuration of the insertion groove and the lead-out hole. Therefore, this difference will be explained below with the same reference numerals being given to the same configurations as in the second embodiment and the explanations thereof will be omitted.

As shown in FIGS. 16-18, the accommodating/holding portion S is provided with an insertion groove 165 extending in the axial direction of the lens barrel 112. The insertion groove 165 has a groove width wider than the width of the extending portion 152 of the FPC heater 150 and a groove depth deeper than the thickness of the extending portion 152. Further, the insertion groove 165 extends from the object-side end of the first accommodating/holding portion S1 to the upper surface of the inner flange portion 124 located at the bottom of the fourth accommodating/holding portion S4. Moreover, the groove bottom of the insertion groove 165 extends straight from the first accommodating/holding portion S1 to the second accommodating/holding portion S2, and extends obliquely inward in the radial direction at the boundary portion between the second accommodating/holding portion S2 and the third accommodating/holding portion S3, thereby forming a stepped portion. Further, the groove bottom of the insertion groove 165 extends straight from the third accommodating/holding portion S3 to the fourth accommodating/holding portion S4.

In the present embodiment, since the insertion groove 165 extends from the object-side end of the first accommodating/holding portion S1 to the upper surface of the inner flange portion 124 located at the bottom of the fourth accommodating/holding portion S4, it is possible to stably support, by virtue of the ten support points SP in a direction orthogonal to the optical axis, the spacer 130 accommodated and held in the first accommodating/holding portion S1, the lens 115 accommodated and held in the accommodating/holding portion S2 in the second accommodating/holding portion S2, the lens 116 accommodated and held in the third accommodating/holding portion S3, and the lens 117 accommodated and held in the fourth accommodating/holding portion S4.

The heating portion 151 of the FPC heater 150 is in close contact with the end face 113a on the image side of the lens 113, and the extending portion 152 is directed toward the insertion groove 165 side and then inserted into the insertion groove 165.

Further, the end face wall 124 on the image side of the lens barrel 112, namely, the inner flange portion 124, is provided with a lead-out hole 166 communicating with the insertion groove 165. The lead-out hole 166 is a rectangular hole, with the hole width being equal to the groove width of the insertion groove 165. The lead-out hole 166 is so formed that it penetrates the end face wall (inner flange portion) 124 of the lens barrel.

Such a lead-out hole 166 is provided for leading the extending portion 152 of the FPC heater 150 (inserted in the insertion groove 165) to the outside of the lens barrel 112, and the extending portion 152 inserted in the insertion groove 165, after being bent at a substantially right angle at the entrance of the lead-out hole 166, is inserted into the lead-out hole 166 and led out from the inner flange portion 124 to the outside.

According to the present embodiment, it is possible to obtain the same effect as that of the second embodiment, and the insertion groove 165 extends in the axial direction of the lens barrel 112, and the lead-out hole 166 communicating with the insertion groove 165 is provided on the end face wall 124 on the image side of the lens barrel 112. Therefore, the extending portion 152 of the FPC heater 150 can be easily led out from the end face wall 124 of the lens barrel 112.

In the second and third embodiments of the present invention, the spacer 130 and the lenses 115, 116, and 117 are accommodated and held in the accommodating/holding portion S, but it is also possible to accommodate and hold only a plurality of lenses, without including the spacer 130.

Further, in the second and third embodiments of the present invention, the accommodating/holding portion SU that accommodates and holds the lens 113 located closest to the object side has an inner peripheral surface formed in a circular shape. On the other hand, it is also possible for the accommodating/holding portion SU to be formed into a shape whose peripheral surface is octagonal or more.

### Fourth Embodiment

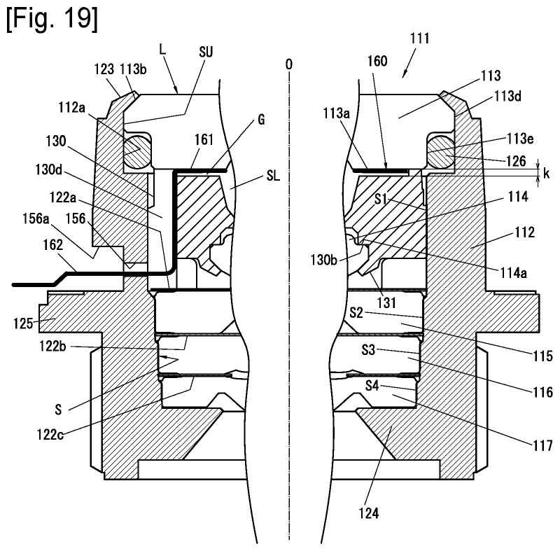

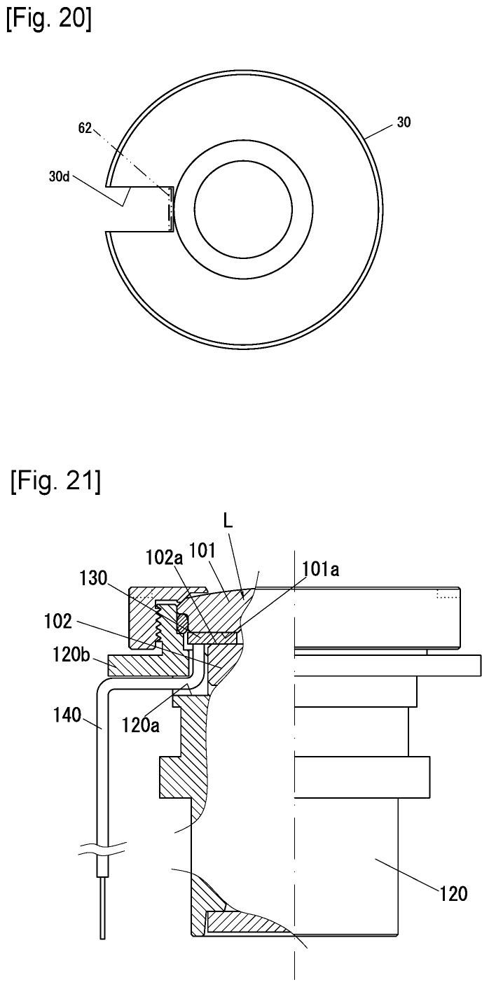

FIGS. 19-20 show a fourth embodiment of the present invention. FIG. 19 is a cross-sectional view of the lens unit 11, and FIG. 20 is a plan view of the spacer 130.

The difference between the lens unit 111 of the fourth embodiment and the lens unit 111 of the third embodiment is in the configuration of the spacer, the configuration of the accommodating/holding portion of the lens barrel 112, and the configuration of the planar heater. Therefore, this difference will be explained below with the same reference numerals being given to the same configurations as in the third embodiment and the explanations thereof will be omitted.

As shown in FIGS. 19-20, the inner peripheral surface of the accommodating/holding portion S is formed into a circular shape. Further, the inner diameter of the accommodating/holding portion S is gradually reduced from the object side to the image side. Correspondingly, the outer diameters of the spacer 130 and the lenses 115, 116, 117 become smaller from the object side toward the image side. Basically, the outer diameters of the spacer 130 and the lenses 115, 116, 117 are substantially equal to the inner diameters of the respective portions of the accommodating/holding portion S of the lens barrel 112 where the spacer 130, the lenses 115, 116, 117 are supported.

Further, as shown in FIG. 19, the accommodating/holding portion S includes a first accommodating/holding portion S1 for accommodating and holding the spacer 30, a second accommodating/holding portion S2 for accommodating the lens 115, a third accommodating/holding portion for accommodating the lens 116, and a fourth accommodating/holding portion S4 accommodating the lens 117, with their inner diameters being gradually reduced from the first accommodating/holding portion S1 toward the fourth accommodating/holding portion S4. Moreover, a stepped surface protruding inward in the radial direction is provided between the accommodating/holding portions adjacent to each other in the axial direction of the lens barrel 112.

Moreover, in the present embodiment, the organic PTC heater 160 is used as the planar heater 160. The organic PTC heater has such a nature that its resistance will increases as its temperature rises, so that after its temperature gradually rises it will be stabilized at a certain temperature. Therefore, it is possible to ensure (by self-control) an appropriate temperature without using an external control such as a sensor. When the temperature reaches an upper limit and stabilizes at such a value, the power consumption can also be stabilized at a low value. Here, the PTC heater 160 may be an inorganic PTC heater or an organic PTC heater, but in the present embodiment, it is preferable to use an organic PTC heater.

Similar to the FPC heater 150, such an organic PTC heater 160 also has a heating portion 161 for heating the first lens and a belt-shaped extending portion 162 extending from the heating portion 161 to supply electricity to the heating portion 161.

The heating portion 161 is formed into a donut plate shape, its outer diameter is substantially equal to the outer diameter of the end face 113a of the first lens 113 on the image side thereof, and its inner diameter is almost equal to the inner diameter of the end face 113a of the first lens 113 on the image side thereof.

Further, the heating portion 161 of the PTC heater 160 is adhered (using an adhesive) to the end face 113a of the first lens 113 on the image side thereof.

As an adhesive, it is preferable to use a thermosetting adhesive such as an epoxy resin or an epoxy resin containing a conductive filler (having an excellent thermal conductivity). The adhesive should be evenly applied to the upper surface (facing the first lens 113) of the heating portion 161 of the PTC heater 160 and/or the end face 113a of the first lens 113 on the image side thereof, followed by bonding together such an upper surface and the end face 113a. Although it is preferable to evenly apply the adhesive, it is also possible to apply such an adhesive to a plurality of predetermined portions so as to realize a desired adhesion.

On the other hand, in the first to third embodiments of the present invention, it is also possible for the heating portions 151, 161 of the planar heaters 150, 160 to be adhered (using an adhesive) to the end face of the first lens 113 on the image side thereof.

Further, the outer peripheral portion of the spacer 130 is provided with an insertion groove (insertion portion) 130d for inserting the extending portion 162 of the planar heater 160 along the axial direction of the lens barrel 112. The insertion groove 130d is formed into a rectangular shape in a plan view, the groove width is wider than the width of the extending portion 162, and the groove depth (depth in the radial direction of the spacer 130) is deeper than the thickness of the extending portion 162.

Moreover, a lead-out hole 156 is provided on the peripheral wall of the lens barrel 112 so as to communicate with the insertion groove 130d. The lead-out hole 156 is a rectangular hole, and the hole width is equal to the groove width of the insertion groove 130d. A rectangular hole 156a is provided on the peripheral wall of the lens barrel 112. The hole 156a is formed to have a larger diameter than the lead-out hole 156 and communicate with the lead-out hole 156. Further, the hole 156a is arranged on the peripheral wall of the lens barrel 112 above the outer flange portion 125. On the other hand, it is also possible for the lead-out hole 156 to be provided below the outer flange portion 125 (on the image side), and for the outlet of the lead-out hole 156 to be arranged, together with the hole 156a, on the peripheral wall of the lens barrel 112 below the outer flange portion 125.

The lead-out hole 156 is provided for leading the extending portion 162 of the PTC heater 160 (inserted in the insertion groove 130d) to the outside of the lens barrel 112, while the extending portion 162 (inserted in the insertion groove 130d), after being bent radially outward at a substantially right angle at the inlet of the lead-out hole 156, is inserted into the lead-out hole 156 and then led to the outside from the hole 156a.

Further, the first lens 113 and the spacer 130 are adjacent to each other in the optical axis direction and are in contact with each other, while a gap for accommodating the heating portion 161 of the PTC heater 160 is provided between the first lens 113 and the spacer 130. Namely, the spacer 130 is so formed that its outer peripheral portion is convex and its inner peripheral side is concave on the surface of the object side, and abuts on the first lens 113 on the outer peripheral side, with a gap K being formed between itself and the first lens 113 on the inner peripheral side. Such a gap K may be like that formed between the first lens 113 and the spacer 130 in the first embodiment.

Further, a gap G is provided between the spacer 130 adjacent to the first lens 113 in the optical axis direction and the heating portion 161 of the PTC heater 160. When the heating portion 161 of the PTC heater 160 is pressurized in the thickness direction, the electric resistance will increase, making it difficult to use the heater.

In order to prevent such pressurization, a gap G is provided between the spacer 130 and the heating portion 61 of the PTC heater 160.

According to the present embodiment, it is of course possible to obtain the same effect as that of the third embodiment. Further, since the gap G is formed between the spacer 130 adjacent to the first lens 113 in the optical axis direction and the heating portion 161 of the PTC heater 160, it is possible to prevent the heating portion 161 from being sandwiched and pressurized between the first lens 113 and the spacer 130, thereby inhibiting a deterioration of the heater performance and ensuring a stable output of the heater. In this way, PTC heater 160 can be easily used.

In this embodiment, as shown in FIG. 19, the outer peripheral portion of the spacer 130 is formed into a convex shape and the inner peripheral side thereof is formed into a concave shape, all on the object side surface of the spacer 130. Further, the outer peripheral side of the spacer 130 abuts on the first lens 113, forming a gap K between itself and the first lens 113 on the inner circumference side. Conversely, the inner peripheral side may be convex and the outer peripheral side may be concave. Moreover, although the spacer 130 is provided with a convex portion, it is also possible to provide a convex portion on the inner peripheral side or the outer peripheral side of the first lens 113 on the image side thereof, making the convex portion to be in contact with the spacer 130.

In the third and fourth embodiments of the present invention, the spacer 130 and the lenses 115, 116, and 117 are accommodated and held in the accommodating/holding portion S, but it is also possible to accommodate and hold only a plurality of lenses in the accommodating/holding portion S. Namely, it is possible for the spacer 130 to be omitted.

Further, in the third and fourth embodiments of the present invention, the accommodating/holding portion SU that accommodates and holds the lens 113 located closest to the object side has an inner peripheral surface formed in a circular shape, but it is also possible for the accommodating/holding portion SU to be formed into a polygonal shape which is octagonal or more.

Moreover, within a range not deviating from the gist of the present invention, it is also possible to combine a part or all of the above-described embodiments, or to omit a part of configuration from one of the above-described embodiments.

### EXPLANATIONS OF NUMERICAL REFERENCES

11,111 lens unit
12, 12A, 112 lens barrel
13,113 first lens
14, 15, 16, 17, 114, 115, 116, 117 lens (optical component)
12d first through hole
12d′ first accommodation groove
12e second through hole
12f accommodation groove (second accommodation groove)
124 inner flange (end face wall)
25A, 25B flange
30,130 spacer (optical component)
50 electrically functional component
52 lead wire (electrical wiring)
70 copper foil (metal foil)
71 circuit pattern
72 circuit layer
75 base film
76 through hole
150 FPC heater (planar heater)
151,161 heating portion
152,152 extending portion
155,130d, 165 insertion groove
156,166 lead-out hole
160 PTC heater (planar heater)
300,400 camera module
L lens group
O optical axis
S accommodating/holding portion
S1 first accommodating/holding portion
S2 second accommodating/holding portion
S3 third accommodating/holding portion
S4 fourth accommodating/holding portion

1. A lens unit having: a lens group including a plurality of lenses arranged along optical axis of these lens; a lens barrel accommodating the lens group, said lens unit comprising:
a flange provided to project radially outward from the lens barrel and useful for attaching the lens unit to other member;
a planar heater located closer to the object side than the flange and capable of heating the first lens located closest to the object side; and
an electrical wiring extending from the planar heater,
wherein
the lens barrel is provided with a first through hole or a first accommodating groove and a second accommodating groove,
the first through hole or the first accommodating groove is extending in the longitudinal direction from the object side to the image side inside the side wall of the lens barrel in order to guide the electrical wiring to a position closer to the image side than the image side end of the flange,
the second accommodating groove is communicated with the first through hole or the first accommodating groove, and extending in the longitudinal direction from the object side to the image side on the outer peripheral surface of the side wall of the lens barrel to accommodate the electrical wiring and guide the electrical wiring to the image side.

2. The lens unit according to claim 1, wherein the lens unit has a second through hole extending radially in the side wall of the lens barrel in order to connect the first through hole or the first accommodating groove with the second accommodating groove.

3. The lens unit according to claim 1, wherein the first through hole or the first accommodating groove and the second accommodating groove are provided in a manner such that a portion of the electrical wiring arranged in the first through hole or the first accommodating groove and a portion of the electrical wiring arranged in the second accommodating groove can be arranged on a straight line in the optical axis direction.

4. The lens unit according to claim 1, wherein the electrical wiring is a lead wire.

5. The lens unit according to claim 1, wherein the electrical wiring is FPC (Flexible Printed Circuit).

6. The lens unit according to claim 1, wherein the electrical wiring is a wiring pattern formed by patterning in the through hole and/or the accommodating groove.

7. A lens unit having: optical components such as a plurality of lenses and spacer arranged along an optical axis; a lens barrel accommodating and holding the optical components; and a planar heater capable of heating a first lens located closest to the object side,
wherein
the lens barrel has an accommodating/holding portion including an inner peripheral surface formed into a polygonal shape having an octagon or more, configured to accommodate and hold the optical components located closer to the image side than the first lens,
the planar heater includes a heating portion for heating the first lens and a belt-shaped extending portion extending from the heating portion to supply electricity to the heating portion,
the accommodating/holding portion is provided with an insertion groove extending in the axial direction of the lens barrel and having a groove width wider than the width of the extending portion,
the lens barrel is provided with a lead-out hole for leading out the extending portion inserted in the insertion groove to the outside, said lead-out hole being communicated with the insertion groove.

8. The lens unit according to claim 7, wherein the lead-out hole is provided on the peripheral wall of the lens barrel.

9. The lens unit according to claim 7, wherein the lead-out hole is provided on the end face wall on the image side of the lens barrel.

10. The lens unit according to claim 7, wherein an angle formed between lines connecting both ends of the insertion groove in the width direction thereof and the center of the accommodating/holding portion is within 60°.

11. The lens unit according to claim 7, wherein the width of the insertion groove is within 3.5 mm.

12. The lens unit according to claim 1, wherein
the planar heater includes a heating portion for heating the first lens,
the heating portion is adhered to the end face of the first lens on the image side thereof using an adhesive.

13. The lens unit according to claim 1, wherein
the first lens and the second lens or spacer are adjacent to each other in the optical axis direction and are in contact with each other,
a gap is provided between the first lens and the second lens or the spacer to accommodate the heating portion of the planar heater.

14. The lens unit according to claim 1, wherein the planar heater is an FPC heater or an organic PTC heater.

15. The lens unit according to claim 1, wherein
the planar heater is an organic PTC heater,
a gap is provided between the second lens or spacer adjacent to the first lens in the optical axis direction and the heating portion of the organic PTC heater.

16. The lens unit according to claim 1, wherein
the planar heater includes a belt-shaped extending portion extending from the heating portion and supplying electricity to the heating portion,
an insertion portion for inserting the extending portion of the planar heater along the axial direction of the lens barrel is provided on the outer peripheral portion of the second lens or the spacer adjacent to the first lens in the optical axis direction,
the lens barrel is provided with a lead-out hole for leading out the extending portion inserted in the insertion portion, said lead-out hole being communicated with the insertion portion.

17. The lens unit according to claim 12, wherein the adhesive is a thermosetting adhesive.

18. The lens unit according to claim 1, wherein
the planar heater is an FPC heater,
the FPC heater includes a heating portion for heating the first lens,
the heating portion has a plurality of circuit layers in which a circuit pattern has been formed by a metal foil.

19. The lens unit according to claim 18, wherein the circuit patterns respectively formed in the circuit layers of a plurality of layers are connected by a through hole.

20. The lens unit according to claim 19, wherein
the lens unit has two circuit layers,
the heating portion has a donut plate-shaped base film,
the circuit layer is provided on both the front and back surfaces of the base film.

21. A camera module including the lens unit according to claim 1.
